(19) United States
(12) Patent Application Publication
(10) Pub. No.: US 2005/0264410 A1
(43) Pub. Date: Dec. 1, 2005

(54) Telemetry technology for measurement devices

(76) Inventors: William P. Kroll, Medina, MN (US); Karl J.F. Kroll, Maple Grove, MN (US); Randie Evenson, Blaine, MN (US); Matthew Young, Golden Valley, MN (US)

Correspondence Address: JOEL D. SKINNER, JR.;SKINNER AND ASSOCIATES, 212 COMMERCIAL ST., HUDSON, WI, 54016, US

(21) Appl. No.: 11/178,826

(22) Filed: Jul. 11, 2005

Related U.S. Application Data
(63) Continuation of application No. 10/177,631, filed on Jun. 18, 2002, now abandoned.
(60) Provisional application No. 60/299,127, filed on Jun. 18, 2001.

(51) Int. Cl. G08B 23/00

(52) U.S. Cl. 340/500; 340/665; 340/666; 340/540; 340/539.24; 340/679; 340/668; 340/539.1; 340/539.26; 340/601; 340/626; 177/25.13

(57) ABSTRACT

A measurement system comprising at least two units, at least one unit having a measurement system, at least one unit having a control and indication system, and each unit having a telemetry system. The system is electronic. The measurement means measures physical characteristics selected from the group consisting of weight, tension, temperature, level, caster, camber, spring rate, pressure, torque, torsion, air density, hardness, sound level, and humidity.

### CROSS-REFERENCE TO RELATED APPLICATIONS, IF ANY

This application claims the benefit under 35 U.S.C. § 119(e) of co-pending U.S. patent application Ser. No. 10/177,631, filed Jun. 18, 2002 which claims the benefit of U.S. Provisional Patent Application Ser. No. 60/299,127, filed Jun. 18, 2001, which is hereby incorporated by reference.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to measurement devices such as electronic weighing scale or device systems. More particularly, the invention relates to the use of telemetry devices and methods to communicatively link plural units of an electronic weighing scale or device system.

2. Background Information

The state of the art includes electronic measurement systems, including electronic weighing scale and other device systems comprising at least two individual units. Such individual units may be weighing devices and/or control devices. Types of weighing scales and devices include devices for weighing or otherwise measuring vehicles (passenger, commercial, automotive racing, military and the like) and components thereof, aircraft and components thereof, freight, and the like. The state of the art further includes telemetry devices and methods.

The prior art specifically includes a crane scale with a radio connected to the standard scale circuitry, namely a Model CS5000 sold since approximately August 1991 by Intercomp Company, applicant's assignee.

This technology is believed to have limitations in terms of combining telemetry devices and methods with electronic weighing scale systems

For this and other reasons, a need exists for the present invention.

This invention provides a telemetry system for electronic measurement system which is believed to fulfil the need and to constitute an improvement over the background technology.

All US patents and patent applications, and all other published documents mentioned anywhere in this application are incorporated by reference in their entirety.

### BRIEF SUMMARY OF THE INVENTION

The present invention provides an electronic measurement (including but not limited to weighing) system with telemetry that permits multiple units separated from each other to communicate without direct physical communicative connection via cables, wires or the like.

In one embodiment, the invention provides a measurement system comprising at least two units, at least one unit having measurement means, at least one unit having control and indication means, each unit having telemetry means. The system is electronic. The measurement means measures physical characteristics selected from the group consisting of weight, tension, temperature, level, caster, camber, spring rate, pressure, torque, torsion, air density, hardness, sound level, and humidity. And the control and indication means indicates physical characteristics selected from the same group. The measurement, and control and indication means may disposed in one unit or the unit having the measurement and control means may not have measurement means. Further, the control and indication means may comprise separate control means and separate indication means. Preferably, there are at least 4 units. Preferably, the telemetry means is that disclosed in appendix A1.

Advantages and significant features of the invention include but are not necessarily limited to improved economy, portability, and ease of use.

The features, benefits and objects of this invention will become clear to those skilled in the art by reference to the following description, claim(s), if any, and drawings.

### DETAILED DESCRIPTION

1. Basic Technology.

The telemetry system for electronic measurement apparatus of the present invention covers axle scales; pallet, walkie, and lift truck scales, digital tensionlink scales, crane scales; and deployment/material handling scale systems, aircraft or high capacity platfor m weighing scale systems, and other scales systems. Examples of such systems are Intercomp product model numbers or product series: AX900, PW Series; TL6000, CS Series, AC30-60, and AC45.

Other systems which the invention may pertain to are wheel load scales (Intercomp Model LP600, PT300, and PT300DW), low profile platform weighing (AC1-25LP), high capacity platform weighing (AC30-60), self contained load cell weighing devices (JWD), Jack Weighing Kits (JW), auto-van-trailer scale systems (SW Deluxe, SWI, and SWII), and floor scales (CW Series).

In one embodiment, the invention provides a measurement system comprising at least two units, at least one unit having measurement means, at least one unit having control and indication means, each unit having telemetry means. The system is electronic. The measurement means measures physical characteristics selected from the group consisting of weight, tension, temperature, level, caster, camber, spring rate, pressure, torque, torsion, air density, hardness, sound level, and humidity. And the control and indication means indicates physical characteristics selected from the same group. The measurement, and control and indication means may disposed in one unit or the unit having the measurement and control means may not have measurement means. Further, the control and indication means may comprise separate control means and separate indication means. Preferably, there are at least 4 units. There may be 18 to 20 units. Preferably, the telemetry means is that disclosed in appendix A1.

In a most preferred embodiment, the invention provides a digital tension link scale system comprising a tension link unit having means to detect and measure tension and telemetry means to send a signal representative of tension and to receive control signals, and a remote control unit having control and indication means and telemetry means to receive signals representative of tension and to send control signals.

2. Other Disclosure Information.

The invention is further described and/or shown in the attached Appendix material which is hereby incorporated by reference as part of the specification.

The Appendix material are substantially self explanatory.
A. 1 page. A radio frequency link used, inter alia, in the TL 6000, AC 3060 and the electronic of other products.
B. 1. A multiple purpose controller (CPU) used in the CS 5000, for example and in connection with electronics in appendix C and D.
C. 1. An MPC serial/set point used with electronics in appendix A and D.
D. 1. An MPC I/O used with electronic in appendix A and C.
E. 1. 20 Bit A/D, Display, Keyboard electronics used in connection with the electronics in appendix F and in many products herein, including the AX 900, PW Series, and TL6000.
F. 1. A/D 20 bit electronic used in connection with electronics in appendix E.
G. 1. A digital load cell used in the AX 900.
H. 1. A/D display board.
I. 8. Wireless transceiver information.
J. 29. AX 900 information.
K. 6. PW Series information.
L. 38. TL 6000 information.
M. 1. AC 45 drawing.
N. 8. Deployment/material handling products information.
O. 38. AC 3060 information.
P. 47. PT 300 wheel load scale system and PT20 Axle Controller and PT300DW wheel load scale system information.
Q. 7. CS Series information.
R. 5. CW Series information.
S. 16. LP600 information.
T. 1. AC and JW Series information.
U. 27. AC 100 information.
V. 63. AC1-25LP platform scale and Aircraft Weighing Software information.
X. 20. SW Series information.

### 3. CONCLUSION

The descriptions above and the accompanying materials should be interpreted in the illustrative and not the limited sense. While the invention has been disclosed in connection with the preferred embodiment or embodiments thereof, it should be understood that there may be other embodiments which fall within the scope of the invention.

1. A measurement system comprising at least two units, at least one unit having measurement means, at least one unit having control and indication means, each unit having telemetry means.

2. The measurement system of claim 1, wherein the system is electronic.

3. The measurement system of claim 1, wherein the measurement means measures physical characteristics selected from the group consisting of weight, tension, temperature, level, caster, camber, spring rate, pressure, torque, torsion, air density, hardness, sound level, and humidity.

4. The measurement system of claim 1, wherein the control and indication means indicates physical characteristics selected from the group consisting of weight, tension, temperature, level, caster, camber, spring rate, pressure, torque, torsion, air density, hardness, sound level, and humidity.

5. The measurement system of claim 1, wherein measurement, and control and indication means are disposed in one unit.

6. The measurement system of claim 1, wherein there are at least 4 units.

7. The measurement system of claim 1, wherein the telemetry means is that disclosed in appendix A1.

8. A digital tension link scale system comprising a tension link unit having means to detect and measure tension and telemetry means to send a signal representative of tension and to receive control signals, and a remote control unit having control and indication means and telemetry means to receive signals representative of tension and to send control signals.
